(19) United States
(12) Patent Application Publication
(10) Pub. No.: US 2007/0143698 A1
(43) Pub. Date: Jun. 21, 2007

(54) Image processing apparatus having enhanced display function

(76) Inventor: Nobuyuki Iwata, Kanagawa (JP)

Correspondence Address: HARNESS, DICKEY & PIERCE, P.L.C., P.O. BOX 8910, RESTON, VA, 20195, US

(21) Appl. No.: 11/600,738

(22) Filed: Nov. 17, 2006

(30) Foreign Application Priority Data
Nov. 17, 2005 (JP) 2005-332511

(51) Int. Cl. G06F 3/00; G03G 15/00; G03G 21/00; G06F 3/12

(52) U.S. Cl. 715/764; 399/9; 399/75; 358/1.1

(57) ABSTRACT

An image processing apparatus includes a display unit, which selectively displays a standby message, an operation message, and an additional message. The standby message indicates a standby condition of the image processing apparatus, and the operation message indicates an operation condition of the image processing apparatus. A message displayed on the display unit is switched from the standby message to the additional message when a time period elapsing from a start of displaying the standby message exceeds a reference value.

### PRIORITY STATEMENT

This application claims the priority under 35 U.S.C. §119 upon Japanese Patent Application No. 2005-332511, filed on Nov. 17, 2005, the disclosure of which is incorporated herein in its entirety by reference.

### BACKGROUND

In general, an image processing apparatus such as copier, facsimile, and printer may include a display unit such as LCD (liquid crystal display) panel for displaying information to notify a status of image processing apparatus to a user (or operator).

Such display unit may display present operation information of the image processing apparatus when the image processing apparatus is conducting an operation such as copying, and may display standby information when the image processing apparatus is in a standby condition.

Furthermore, such display unit may display error information when the image processing apparatus is in an error condition such as exhaustion of consumable supplies-and-material (e.g., sheet empty condition), for example.

From a viewpoint of displaying more detailed information of the image processing apparatus, the display unit may have a larger screen size so that various types of information can be displayed on a screen of the display unit.

However, such a display unit having a larger screen size may increase manufacturing cost of image processing apparatus.

Accordingly, a conventional image processing apparatus may be equipped with a relatively smaller-sized display unit to reduce the manufacturing cost of an image processing apparatus. For example, a printer may be equipped with a LCD panel, which can display one or two lines at most.

Accordingly, such a display unit having a limitation of the size and/or amount of information that can be displayed although such display-capacity has been increasing to improve a usability of image processing apparatus.

A related image processing apparatus can provide information of image processing conditions by printing information on a sheet. For example, such information may be toner empty notice.

However, such an image processing apparatus may not be desirable from a viewpoint of material saving such as reducing numbers of printed sheets and usability such as real-time information checking.

### SUMMARY

An example embodiment of the present invention relates to an image processing apparatus. Such an apparatus may include: a memory to store a standby message, an operation message, and an additional message, the standby message indicating a standby condition of the image processing apparatus, and the operation message indicating an operation condition of the image processing apparatus; and a notification unit to selectively output the messages obtainable from the memory, respectively, and to switch from outputting the standby message to the outputting additional message when a time period elapsing from a start of outputting the standby message exceeds a reference value.

An example embodiment of the present invention also relates to a method of displaying a message on a display unit of an image processing apparatus. Such a method may include: storing a standby message indicating a standby condition of the image processing apparatus, an operation message indicating an operation condition of the image processing apparatus, and an additional message; selectively controlling content of a message output by the notification unit to be one of the standby message, the operation message and the additional message, respectively; and switching content of a message output by the notification unit from the standby message to the additional message when a time period elapsing from a start of displaying the standby message exceeds a reference value.

Additional features and advantages of the present invention will be more fully apparent from the following detailed description of example embodiments, the accompanying drawings and the associated claims.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram of an image processing apparatus according to an example embodiment of the present invention;

FIG. 2 is a flowchart for explaining a control process (according to an example embodiment of the present invention) for displaying information of an image processing apparatus;

FIGS. 3A to 3G are example displays (according to example embodiments of the present invention, respectively) on an operation panel of an image processing apparatus;

FIG. 4 is a schematic view of another operation panel (according to example embodiments of the present invention) of an image processing apparatus; and

FIG. 5 is a flowchart for explaining another control process (according to example embodiments of the present invention) for displaying information of an image processing apparatus.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

It will be understood that if an element or layer is referred to as being “on,” “against,” “connected to” or “coupled to” another element or layer, then it can be directly on, against connected or coupled to the other element or layer, or intervening elements or layers may be present. In contrast, if an element is referred to as being “directly on”, “directly connected to” or “directly coupled to” another element or layer, then there are no intervening elements or layers present. Like numbers refer to like elements throughout. As used herein, the term “and/or” includes any and all combinations of one or more of the associated listed items.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

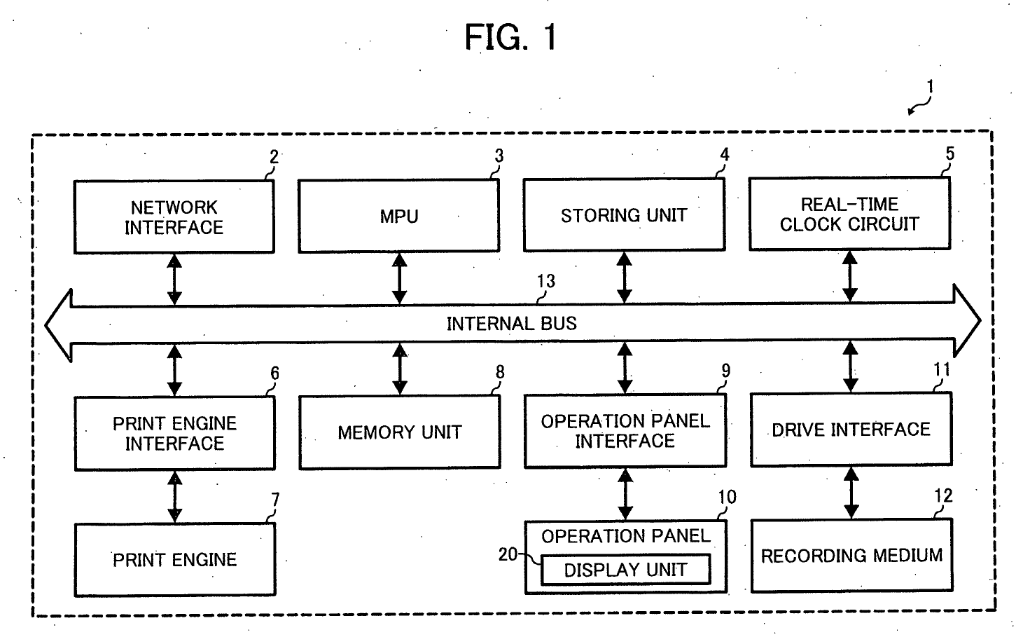

Referring now to the drawings, wherein like reference numerals designate identical or corresponding parts throughout the several views, an image processing apparatus according to some example embodiments of the present invention is described with particular reference to FIGS. 1 to 3.

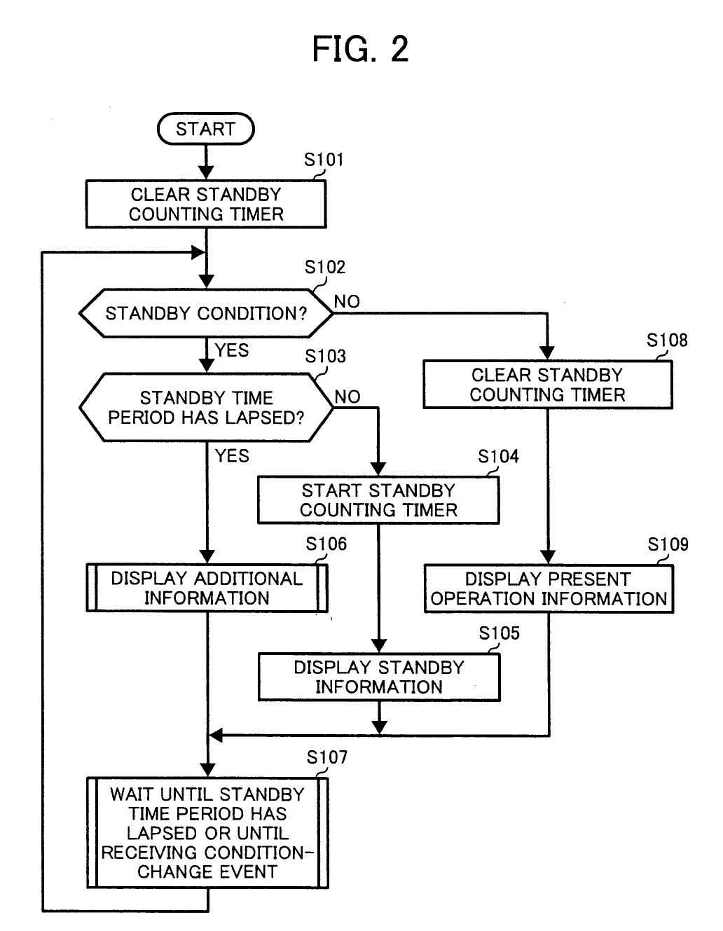

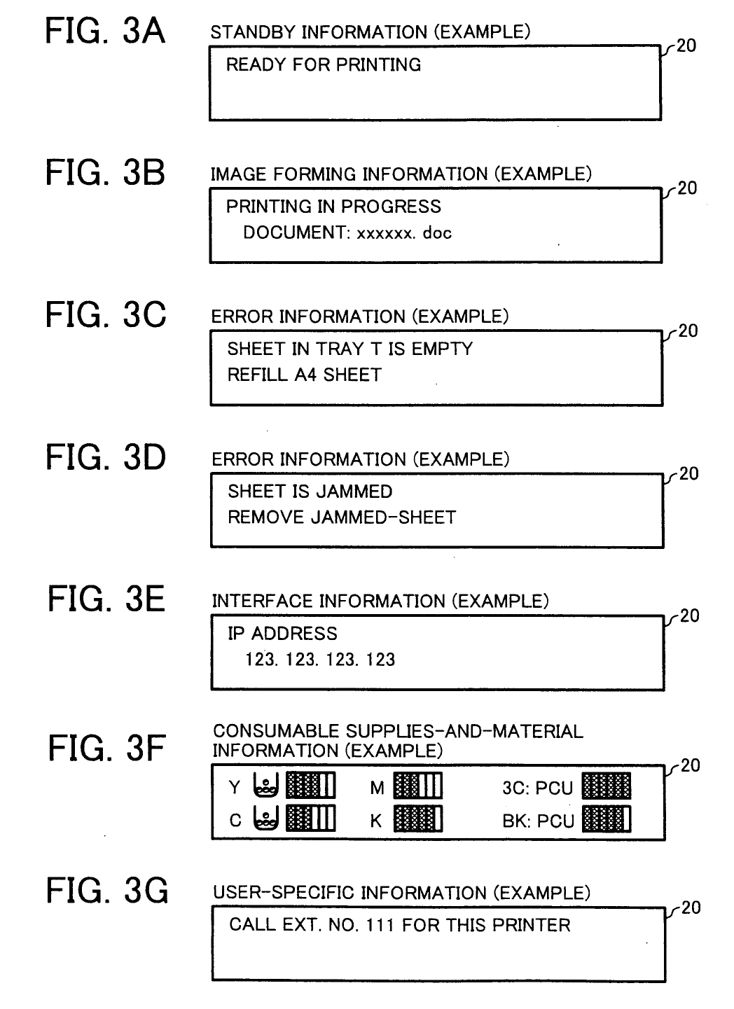

More particularly, FIG. 1 is a block diagram of an image processing apparatus 1 according to an example embodiment of the present invention. FIG. 2 is a flowchart for explaining a control process (according to an example embodiment of the present invention) for displaying information pertaining to an image processing apparatus, e.g., 1. FIGS. 3A to 3G are example displays (according to example embodiments of the present invention, respectively) on an operation panel, e.g., 10 of the image processing apparatus 1.

As shown in FIG. 1, the image processing apparatus 1 includes a network interface 2, a MPU (micro processing unit) 3, a storing unit 4, a real-time clock circuit 5, a print engine interface 6, a print engine 7, a memory unit 8, an operation panel interface 9, an operation panel 10, a drive interface 11, a recording medium 12, and an internal bus 13 connecting the above-mentioned units or devices each other, for example.

The network interface 2 is connected to a network (not shown), and the network is further connected to a host apparatus (not shown) such as personal computer, for example.

The network interface 2 receives control signals or data from the host apparatus (e.g., personal computer) on the network, and sends such control signals or data to the image processing apparatus 1. Furthermore, the network interface 2 sends status signals from the image processing apparatus 1 to the host apparatus via the network.

The storing unit 4 stores, e.g., an operating program for the image processing apparatus 1, application programs such as a display program, data for executing such application programs, etc.

The memory unit 8 may be used, e.g., as working memory for the MPU 3, as buffer memory for temporally storing data transmitted from the host apparatus, as bitmap memory for storing video data (e.g., obtained by converting data, memorized in the buffer memory, to a print pattern), etc.

The MPU 3 uses the memory unit 8 as working memory for a program in the storing unit 4, and controls the image processing apparatus 1 as a whole.

The MPU 3 processes data (e.g., print data, control data) transmitted from the host apparatus, for example, and controls a printing process and a display process, for example.

The real-time clock circuit 5 includes an oscillator and a frequency demultiplier to generate clock signals as time information.

The MPU 3 reads clock signals transmitted from the real-time clock circuit 5 to compute a present time, and use the clock signals to control operation or processing in the image processing apparatus 1, for example.

The print engine interface 6 is connected to the print engine 7. The print engine interface 6 transmits control signals and video signals to the print engine 7, and receives status signals from the print engine 7.

The print engine 7 conducts an image forming process using video signals and control signals received via the print engine interface 6. For example, the print engine 7 conducts an image forming process such as printing process by electrophotography.

In case of electrophotography, for example, the print engine 7 may include a photosensitive member, an optical writing unit, a developing unit, a charging unit, a cleaning unit, and a fixing unit, which are required for printing images on a recording medium (e.g., sheet).

Specifically, the print engine 7 activates the optical writing unit with video signals and control signals to form a latent image on the photosensitive member, and develops the latent image on the photosensitive member as toner image by supplying toners onto the photosensitive member from the developing unit. Then, the print engine 7 instructs a sheet feeder to feed a sheet into a space between the photosensitive member and transfer member so that the toner image is transferred from the photosensitive member to the sheet. The print engine 7 further instructs a transportation of sheet to the fixing unit to fix the toner image on the sheet. The fixing unit may apply heat and pressure to the sheet to fix the toner image on the sheet. With such process, an image can be formed on the sheet with the image processing apparatus 1.

The operation panel interface 9 is connected to the operation panel 10.

The operation panel 10 includes a notification unit to notify/provide a user with information, e.g., a display unit 20, and operation keys, wherein the display unit 20 produces a visual output by displaying information of the image processing apparatus 1, and a user can instruct to the image processing apparatus 1 with operation keys. As an alternative to, or in addition to, the display unit 20, the notification unit can include a sound unit to produce an auditory output to convey such information.

The operation panel interface 9 conducts an interface process between the MPU 3 and operation panel 10.

The drive interface 11 is connected to the recording medium 12.

For example, the recording medium 12 may include an optical disk such as CD-ROM (compact disc read only memory), CD-R (compact disc recordable), CD-RW (compact disc rewritable), DVD-ROM (digital video disk read only memory), DVD-R (digital video disk recordable), and DVD-RW (digital video disk rewritable); compact flash memory; memory stick (MS); smart media; memory card; floppy disk; zip; MO (magnetic optical disk); MD (mini disc); DAT (digital audio tape); DCC (digital compact cassette); magnetic card, and IC (integrated circuit) card.

The drive interface 11 writes data to the recording medium 12, and read outs data from the recording medium 12.

Hereinafter, a method of displaying information on the display unit 20 of the image processing apparatus 1 is explained.

The image processing apparatus 1 includes the operation panel 10 having the display unit 20, via which display of information regarding the image processing apparatus 1 may be selectively switched depending on conditions of the image processing apparatus 1.

For example, the image processing apparatus 1 may display standby information on the display unit 20 for a given standby time period, and the image processing apparatus 1 may switch information displayed on the display unit 20 from the standby information to additional information when an elapsed time in which the standby condition is satisfied has exceeded a reference value corresponding to the given standby time period. The additional information may be set, e.g., in advance for the image processing apparatus 1, as required.

As such, the image processing apparatus 1 may switchingly display information on the display unit 20.

Hereinafter, such a display process is explained with reference to FIG. 2.

At first, the image processing apparatus 1 is set to power-ON condition to activate the image processing apparatus 1. The image processing apparatus 1 may become power-ON condition from power-OFF condition by pressing a power switch, for example.

At step S101, the MPU 3 clears a standby counting timer. When the MPU 3 clears the standby counting timer, the standby counting timer has not yet begun to count a standby time period, i.e., monitoring of an elapse of time has not yet commenced.

As described later, the standby counting timer starts to count the standby time period with an instruction of the MPU 3 at a given timing, wherein the standby time period may be set, e.g., in advance. For example, the standby time period can be set when the image processing apparatus 1 is manufactured. However, a user can change a time period of the standby time period with operating keys on the operation panel 10, as required. Alternatively, the time period can be set, e.g., automatically in an adaptive manner based upon, e.g., conditions of the image processing apparatus 1.

At step S102, the MPU 3 checks whether the image processing apparatus 1 is in a standby condition.

If the MPU 3 confirms that the image processing apparatus 1 is in a standby condition at step S102, then the MPU 3 checks at step S103 the standby counting timer to determine whether the standby time period has lapsed.

If the MPU 3 confirms that the standby time period has not yet lapsed, then the MPU 3 instructs the standby counting timer to start a time-counting operation at step S104, and then the MPU 3 advances the process to step S105.

At step S105, the display unit 20 displays standby information on the display unit 20. For example, the standby information may include “ready for printing” as shown in FIG. 3A.

The display unit 20 may display various types of information in two lines, e.g., as shown in FIG. 3A to FIG. 3G. However, numbers of lines used for displaying information may be changed depending on a size of display unit 20.

After step S105, the MPU 3 advances the process to step S107.

At step S107, the MPU 3 may maintain a display of the standby information on the display unit 20 until the MPU 3 receives a signal of condition-change event.

The condition-change event may mean a condition change in the image processing apparatus 1 such as a change, e.g., from “now printing” to “standby,” from “now printing” to “error occurs,” from “standby” to “now printing,” etc.

If the MPU 3 confirms that the MPU 3 receives a signal of condition-change event at step S107, then the MPU 3 returns the process to step S102.

At step S102, the MU 3 checks whether the image processing apparatus 1 is in a standby condition.

If the MPU 3 confirms that the image processing apparatus 1 is in a standby condition at step S102, then the MPU 3 checks whether the standby time period has lapsed with the standby counting timer at step S103.

If the MPU 3 confirms that the standby time period has lapsed with the standby counting timer at step S103, then the MPU 3 switches information displayed on the display unit 20 from standby information to additional information at step S106.

The additional information may include interface information, consumable supplies-and-material information, and user-specific information, e.g., as shown in FIGS. 3E, 3F, and 3G, for example.

The additional information may be set when the image processing apparatus 1 is manufactured, or may be set whenever a user wants to add information.

The interface information may include “IP (internet protocol) address” as shown in FIG. 3E, for example.

The consumable supplies-and-material information may include “remaining amount of toners” as shown in FIG. 3F, for example. As shown in FIG. 3F, information displayed on the display unit may include a pictorial symbol in addition to a character or letter.

The user-specific information may include “call extension telephone number 111 for this printer” as shown in FIG. 3G, for example.

The user-specific information can be set to the image processing apparatus 1 as below.

Specifically, a user can use operation keys of the operation panel 10 to set and register user-specific information to the storing unit 4 of the image processing apparatus 1, or a user can use a personal computer, connected to the image processing apparatus 1 via the network interface 2, to send user-specific information to the image processing apparatus 1 so that the user-specific information can be registered in the storing unit 4 of the image processing apparatus 1.

As above explained, the additional information may not be limited to one type of information, but may include a plurality of types of information.

If the plurality of types of information is registered as additional information, for example, the MPU 3 may instruct the display unit 20 to display additional information as below.

Specifically, for example, the MPU 3 may selectively switch among the plurality of types of additional information, e.g., one by one, on the display unit 20 according to a switching time interval. The switching time interval may be set with any value, depending on a usage of image processing apparatus, for example.

Furthermore, the MPU 3 may select information to be displayed on the display unit 20 from among the plurality of types of additional information according to a user request. A user may request such information via operation keys of the operation panel 10, by which a number and types of information to be displayed on the display unit 20 can be adjusted (e.g., increased or decreased).

After step S106, the MPU 3 advances the process to step S107.

At step S107, the MPU 3 may maintain a display of the additional information on the display unit 20 until the MPU 3 receives a signal of condition-change event. The condition-change event may include a condition change in the image processing apparatus 1 such as, e.g., from “now printing” to “standby,” from “now printing” to “error occurs,” from “standby” to “now printing,” etc.

If the MPU 3 confirms that the standby counting timer counts the standby time period or the MPU 3 receives a signal of condition-change event at step S107, the MPU 3 returns the process to step S102.

At step S102, the MPU 3 checks whether the image processing apparatus 1 is in a standby condition at step S102.

If the MPU 3 confirms that the image processing apparatus 1 is not in a standby condition at step S102, the MPU 3 advances the process to step S108.

At step S108, the MPU 3 clears the standby counting timer, and advances the process to step S109.

At step S109, the MPU 3 displays present operation information of the image processing apparatus 1 on the display unit 20. The present operation information may include image forming information and/or error information, for example.

The image forming information may include “printing in progress” and “document name” as shown in FIG. 3B, for example.

The error information may indicate that an error is now occurring in the image processing apparatus 1. For example, if a sheet tray becomes empty, the display unit 20 may display “sheet in tray T is empty” and “refill A4 sheet” as shown in FIG. 3C, and if a sheet jamming occurs in the image processing apparatus 1, the display unit 20 may display “sheet is jammed” and “remove jammed-sheet” as shown in FIG. 3D.

After step S109, the MPU 3 advances the process to step S107.

At step S107, the MPU 3 may maintain a display of the present operation information on the display unit 20 until the MPU 3 receives a signal of condition-change event.

The condition-change event may include a condition change in the image processing apparatus 1 such as, e.g., from “now printing” to “standby,” from “now printing” to “error occurs,” from “standby” to “now printing,” etc.

If the MPU 3 confirms that the MPU 3 receives a signal of condition-change event at step S107, the MPU 3 returns the process to step S102.

When the MPU 3 returns the process to step S102, the MPU 3 may control the process again with the above-explained sequences such as steps S102, S103, S106 and S107, steps S102, S103, S104, S105 and S107, and steps S102, S108 and S109.

In the above described example embodiment, if the MPU 3 confirms that the standby condition has lapsed the standby time period, the MPU 3 switches information displayed on the display unit 20 from standby information to additional information.

However, the MPU 3 may instruct the display unit 20 not to display the additional information even when the standby condition has lapsed the standby time period in the image processing apparatus 1.

For example, when the standby condition has lapsed the standby time period in the image processing apparatus 1, the MPU 3 may instruct a display of additional information on the display unit 20 if a display function of additional information is set to “valid” by operation keys of the operation panel 10, or the MPU 3 may not instruct a display of additional information on the display unit 20 if a display function of additional information is set to “invalid” by operation keys of the operation panel 10.

As such, in an example embodiment, the image processing apparatus 1 may switch information displayed on the display unit 20 from standby information to additional information when an elapse of time in the standby condition has exceeded the standby time period, e.g., wherein the additional information may be set in the image processing apparatus 1 in advance, or may be set by a user, as required.

Accordingly, without enlarging a screen size of the display unit 20, the display unit 20 may display the above-explained additional information, standby information, and present operation information at a given timing, by which a usability of the image processing apparatus 1 may be enhanced.

Furthermore, if an operation such as printing is requested to the image processing apparatus 1 when the display unit 20 displays additional information, e.g., the MPU 3 can stop displaying additional information, and starts to display information of requested operation on the display unit 20, by which a usability of the image processing apparatus 1 may be enhanced.

Furthermore, in the image processing apparatus 1, a user can select a display or non-display of additional information on the display unit 20 for each of additional information with operation keys of the operation panel 10. Based on a selection by the user, the MPU 3 may select display or non-display to each of additional information.

Furthermore, in the image processing apparatus 1, a user can change and set a time period of the standby time period with operating keys on the operation panel 10, as required. Based on a setting result of standby time period by the user, the MPU 3 can display additional information on the display unit 20 when a standby time period set by the user has lapsed.

Accordingly, based on usage history information of the image processing apparatus 1, a user can select display or non-display to each of additional information with operation keys of the operation panel 10, and can set a standby time period used for determining display timing of additional information on the display unit 20, by which a usability of the image processing apparatus 1 may be enhanced.

Furthermore, the image processing apparatus 1 can register a plurality of additional information such as first additional information and second additional information.

If a display of second additional information is requested in the image processing apparatus 1 when the first additional information is displayed on the display unit 20, the MPU 3 may switch information displayed on the display unit 20 from the first additional information to the second additional information.

Accordingly, the image processing apparatus 1 can display additional information, which is requested by a user, by which a usability of the image processing apparatus 1 may be enhanced.

Furthermore, in the image processing apparatus 1, the MPU 3 can sequentially display a plurality of additional information on the display unit 20 with a switching time interval.

Accordingly, the image processing apparatus 1 can notify various types of additional information to a user by displaying various types additional information on the display unit 20, e.g., in a sequential manner, by which a usability of the image processing apparatus 1 may be enhanced.

Furthermore, in the image processing apparatus 1, a user can select types and numbers of additional information, the display of which on the display unit 20 can be selectively switched according to a switching time interval. With such configuration, the user can check selected additional information on the display unit 20.

Accordingly, the image processing apparatus 1 can selectively display additional information requested by the user, by which a usability of the image processing apparatus 1 may be enhanced.

Furthermore, in the image processing apparatus 1, a user can set a switching time interval to an optional value, which is used for determining when to switch what is being displayed from among a plurality of additional information.

For example, the switching time interval may be set to a longer time so that a user can recognize additional information on the display unit 20 more clearly.

Accordingly, the image processing apparatus 1 can display additional information on the display unit 20 with a switching time interval, set by the user, by which a usability of the image processing apparatus 1 may be enhanced. Such switching time interval may be set to the image processing apparatus 1 when the image processing apparatus 1 is manufactured, but may be changed with referring usage history information of the image processing apparatus 1, for example.

Furthermore, in the image processing apparatus 1, a user can register new additional information by referring setting condition and usage history information of the image processing apparatus 1, as required, and the image processing apparatus 1 can display such registered additional information on the display unit 20.

Accordingly, the image processing apparatus 1 can display additional information required by a user on the display unit 20, by which a usability of the image processing apparatus 1 may be enhanced.

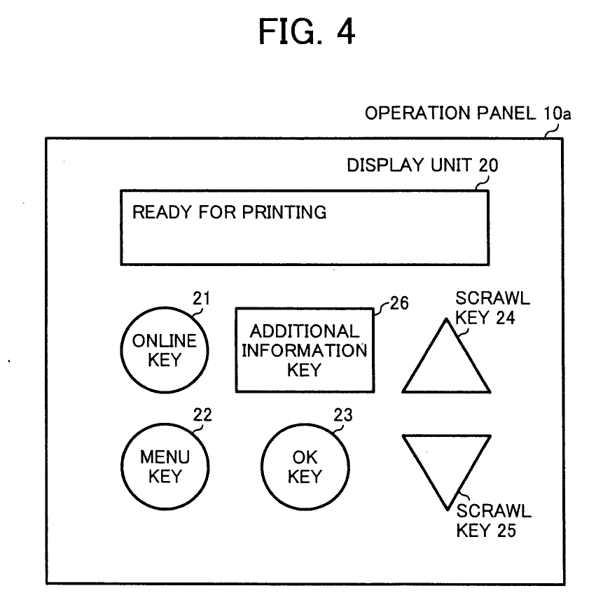

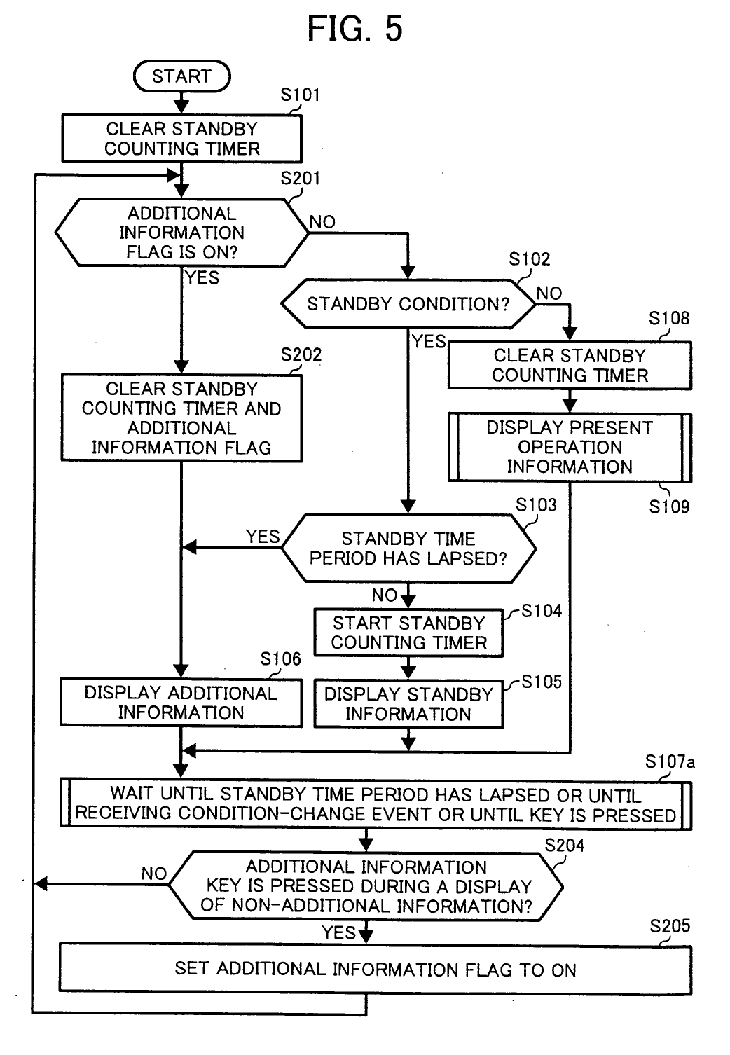

Hereinafter, another example embodiment is explained with FIGS. 4 and 5.

FIG. 4 is a schematic view of another operation panel 10a (according to an example embodiment of the present invention) of an image processing apparatus. FIG. 5 is a flowchart for explaining another control process (according to an example embodiment of the present invention) for displaying information of image processing apparatus.

An image processing apparatus to be explained with FIGS. 4 and 5 has a similar configuration explained in the above with reference FIGS. 1 to 3.

Therefore, in the following explanation, the image processing apparatus to be explained with FIGS. 4 and 5 may have some similar reference characters of the image processing apparatus 1 explained in the above with reference to FIGS. 1 to 3.

As shown in FIG. 4, the operation panel 10a includes a display unit 20, an online key 21, a menu key 22, an OK key 23, scrawl keys 24 and 25, and an additional information key 26, for example.

The online key 21 may be used to instruct a process to the image forming apparatus via on-line.

The menu key 22 may be used to display a menu mode on the display unit 20, wherein the menu mode includes a plurality of menus, in general.

The OK key 23 may be pressed when to confirm an operation selected by operating keys on the operation panel 10a.

The scrawl keys 24 and 25 may be used to scrawl a plurality of information displayed on the display unit 20 in up/down direction in the display unit 20.

The additional information key 26 may be used, e.g., to switch information displayed on the display unit 20 from standby information/present operation information to additional information or from additional information to standby information/present operation information. That is, the additional information key 26 may be used to toggle between displays of such information.

Specifically, e.g., if a user presses the additional information key 26 when additional information is displayed on the display unit 20, the MPU 3 stops displaying the additional information, and the MPU 3 switches information displayed on the display unit 20 from additional information to standby information or present operation information.

Furthermore, e.g., if a user presses the additional information key 26 when standby information or present operation information is displayed on the display unit 20, the MPU 3 stops displaying the standby information or present operation information, and the MPU 3 switches information displayed on the display unit 20 from standby condition or present operation information to additional information.

FIG. 5, again, is a flowchart for explaining another control process for displaying information of the image processing apparatus 1. FIG. 5 has some similar steps shown in FIG. 2, and an explanation for such similar steps may be omitted in the following explanation.

At first, the image processing apparatus 1 is set to power-ON condition to activate the image processing apparatus 1. The image processing apparatus 1 may become power-ON condition from power-OFF condition by pressing a power switch, for example.

At step S101, the MPU 3 clears a standby counting timer.

At step S201, the MPU 3 checks whether an additional information flag is set to “ON” or “OFF” condition.

As described later, the MPU 3 sets the additional information flag to “ON” condition when the additional information key 26 on the operation panel 10a is pressed.

If the MPU 3 confirms that the additional information flag is set to “OFF” condition (i.e., not “ON” condition) at step S201, the MPU 3 checks whether the image processing apparatus 1 is in a standby condition at step S102.

If the MPU 3 confirms that the image processing apparatus 1 is in a standby condition at step S102, the MPU 3 checks at step S103 the standby counting timer to determine whether a standby time period has lapsed.

If the MPU 3 confirms that that the standby time period has not yet lapsed at step S103, the MPU 3 instructs the standby counting timer to start a time-counting operation at step S104.

At step S105, the MPU 3 instructs the display unit 20 to display standby information (e.g., see FIG. 3A). After Step S105, the MPU 3 advances the process to Step 107a.

At step S107a, the MPU 3 may maintain a display of the standby information on the display unit 20 until the count of the standby counting timer exceeds the standby time period, until the MPU 3 receives a signal of condition-change event, or until the additional information key 26 is pressed.

If, while waiting at the step S107a, the MPU 3 does any of (A) confirm that the count of the standby counting timer exceeds the standby time period, (B) receive a signal of condition-change event or (C) detect that the additional information key 26 has been pressed, then the MPU 3 checks whether the additional information key 26 is pressed during a display of non-additional information (e.g., standby information and present operation information) at step S204.

If the MPU 3 confirms that the additional information key 26 is not pressed during a display of non-additional information (e.g., standby information and present operation information) at step S204, then the MPU 3 returns the process to step S201.

At step S201, the MPU 3 checks whether an additional information key flag is set to “ON” or “OFF” condition.

If the MPU 3 confirms that an additional information key flag is set to “OFF” condition (i.e., not “ON” condition) at step S201, then the MPU 3 checks whether the image processing apparatus 1 is in a standby condition at step S102.

If the MPU 3 confirms that the image processing apparatus 1 is in a standby condition at step S102, then the MPU 3 checks whether the standby time period has lapsed with the standby counting timer at step S103.

If the MPU 3 confirms that the standby time period has lapsed at step S103, then the MPU 3 advances the process to step S106.

At step S106, the MPU 3 switches information displayed on the display unit 20 from the standby information to additional information. The additional information may include information shown in FIGS. 3E to 3G, for example. After step S106, the MPU 3 advances the process to step S107a.

At step S107a, the MPU 3 may maintain a display of the additional information on the display unit 20 until the MPU 3 receives a signal of condition-change event, or until the additional information key 26 is pressed.

If the MPU 3 confirms that the MPU 3 receives a signal of condition-change event, or the MPU 3 detects an pressing of additional information key 26 at step S107a, then the MPU 3 checks whether the additional information key 26 is pressed during a display of non-additional information (e.g., standby information and present operation information) at step S204.

If the MPU 3 confirms that the additional information key 26 is not pressed during a display of non-additional information (e.g., standby information and present operation information) at step S204, then the MPU 3 returns the process to step S201.

At step S201, the MPU 3 checks whether the additional information key flag is set to “ON” or “OFF” condition.

If the MPU 3 confirms that the additional information key flag is set to “OFF” condition (i.e., not “ON” condition) at step S201, then the MPU 3 checks whether the image processing apparatus 1 is in a standby condition at step S102.

If the MPU 3 confirms that the image processing apparatus 1 is not in a standby condition at step S102 (i.e., image processing apparatus 1 is conducting an operation), then the MPU 3 clears the standby counting timer at step S108. Then, the MPU 3 advances the process to step S109.

At step S109, the MPU 3 instructs the display unit 20 to display present operation information. The present operation information may include information shown in FIGS. 3B to 3D, for example.

The MPU 3 displays the present operation information on the display unit 20 at step S109, and then the MPU 3 advances the control process to step S107a.

At step S107a, the MPU 3 may maintain a display of the present operation information on the display unit 20 until the MPU 3 receives a signal of condition-change event, or until the additional information key 26 is pressed.

If the MPU 3 confirms that the MPU 3 receives a signal of condition-change event, or the MPU 3 detects an pressing of additional information key 26 at step S107a, then the MPU 3 checks whether the additional information key 26 is pressed during a display of non-additional information (e.g., standby information and present operation information) at step S204.

If the MPU 3 confirms that the additional information key 26 is pressed during a display of non-additional information (e.g., standby information and present operation information) at step S204, then the MPU 3 sets the additional information flag to “ON” condition at step S205, and the MPU 3 returns the process to step S201.

At step 201, the MPU 3 checks whether the additional information key flag is set to “ON” or “OFF” condition.

If the MPU 3 confirms that the additional information key flag is set to “ON” condition at step S201, then the MPU 3 clears the standby counting timer and also clears the additional information flag at step S202.

Then, at step S106, the MPU 3 displays additional information on the display unit 20. After step S106, the MPU 3 advances the process to step S107a.

At step S107a, the MPU 3 may maintain a display of the additional information on the display unit 20 until the MPU 3 receives a signal of condition-change event, or until the additional information key 26 is pressed.

If the MPU 3 confirms that the MPU 3 receives a signal of condition-change event, or the MPU 3 detects an pressing of additional information key 26 at step S107a, then the MPU 3 checks whether the additional information key 26 is pressed during a display of non-additional information (e.g., standby information and present operation information) at step S204.

If the MPU 3 confirms that the additional information key 26 is pressed during a display of non-additional information (e.g., standby information and present operation information) on the display unit 20 at step S204, then the MPU 3 switches information displayed on the display unit 20 from the non-additional information (e.g., standby information and present operation information) to additional information.

If the MPU 3 confirms that the additional information key 26 is not pressed at step S204, then the MPU 3 returns the process to step S201.

Then, the MPU 3 controls the process as above-described manner such as from steps S201, S202 to S205, or from steps S102 to S108, S109, for example.

As above described, at step S106, the MPU 3 displays the additional information on the display unit 20, and advances the process to step S107a.

At step S107a, the MPU 3 may maintain a display of the additional information on the display unit 20 until the MPU 3 receives a signal of condition-change event, or until the additional information key 26 is pressed.

If the MPU 3 confirms that the MPU 3 receives a signal of condition-change event or the additional information key 26 is pressed at step 107a, then the MPU 3 advances the control process to step S204.

At step S204, the MPU 3 checks whether the additional information key 26 is pressed during a display of non-additional information (e.g., standby information and present operation information).

As above-mentioned, the additional information is displayed on the display unit 20 at step S106, and may be displayed on the display unit 20 at step S107 and at step S204. If the additional information key 26 is pressed during a display of additional information at step S204, then the MPU 3 does not set an additional information flag to “ON” condition at step S204, and advances the process to step S201.

At step S201, the MPU 3 checks whether the additional information flag is set to “ON” or “OFF” condition.

If the additional information flag is in “OFF” condition at step S201, then the MPU 3 checks whether the image processing apparatus 1 is in a standby condition at step S102.

If the MPU 3 confirms that the image processing apparatus 1 is in a standby condition at step S102, then the MPU 3 advances the process to steps S103 to S105 and displays standby information on the display unit 20.

If the MPU 3 confirms that the image processing apparatus 1 is not in a standby condition step S102, then the MPU 3 advances the process to steps S108 and S109 and displays present operation information on the display unit 20.

Accordingly, if the MPU 3 confirms that the additional information key 26 is pressed during a display of additional information on the display unit 20, the MPU 3 switches information displayed on the display unit 20 from additional information to non-additional information (e.g., standby information and present operation information).

As above described, the image processing apparatus 1 may selectively switch between the display of additional information and non-additional information (e.g., standby information and present operation information) on the display unit 20 by operating the additional information key 26.

Accordingly, a user (or operator) can display information that the user (or operator) wants to know at a user-preferable timing on the display unit 20, by which a usability of the image processing apparatus 1 may be enhanced.

In the above-described example embodiments, the image processing apparatus 1 includes a display unit for displaying standby information and various types of present operation information. Such image processing apparatus 1 may be used as various types of apparatuses such as, e.g., copier, printer, multifunctional apparatus, facsimile, scanner, etc.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

What is claimed is:

1. An image processing apparatus comprising:
a memory to store a standby message, an operation message, and an additional message, the standby message indicating a standby condition of the image processing apparatus, and the operation message indicating an operation condition of the image processing apparatus; and
a notification unit to selectively output the messages obtainable from the memory, respectively, and to switch from outputting the standby message to outputting the additional message when a time period elapsing from a start of outputting the standby message exceeds a reference value.

2. The image processing apparatus according to claim 1, wherein the operation message includes at least one of an image processing message and an error message.

3. The image processing apparatus according to claim 1, wherein the notification unit stops outputting the additional message when an operation is requested to the image processing apparatus during an output of the additional message, and then starts to output an operation message corresponding to the requested operation.

4. The image processing apparatus according to claim 1, further comprising a controller configured to do at least the following:
instruct the notification unit to output the standby message, operation message, and additional message; and
instruct the notification unit to switch among outputting the standby message, operation message, and additional message.

5. The image processing apparatus according to claim 1, further comprising a setting unit configured to select an output mode or a non-output mode for the notification unit regarding the additional message, and further configured to set the reference value.

6. The image processing apparatus according to claim 4, wherein there is a plurality of additional messages including at least a first additional message and a second additional message, and wherein the controller instructs the notification unit to switch a message displayed thereon from the first additional message to the second additional message when the second additional message is designated while the first additional message is being output.

7. The image processing apparatus according to claim 6, wherein the controller instructs the notification unit to switch amongst a number of the additional messages from the plurality thereof.

8. The image processing apparatus according to claim 7, wherein the number of additional messages, selected from among the plurality, is variable.

9. The image processing apparatus according to claim 7, wherein the time interval is a variable.

10. The image processing apparatus according to claim 1, wherein the additional message includes information provided by a user via an interface to the image processing apparatus.

11. A method of outputting a message on a notification unit of an image processing apparatus, the method comprising:
storing a standby message indicating a standby condition of the image processing apparatus, an operation message indicating an operation condition of the image processing apparatus, and an additional message;
selectively controlling content of a message output by the notification unit to be the standby message, the operation message and the additional message, respectively; and
switching content of a message output by the notification unit from the standby message to the additional message when a time period elapsing from a start of displaying the standby message exceeds a reference value.

12. The method according to claim 11, further comprising stopping an output of the additional message when an operation is requested to the image processing apparatus during output of the additional message, and then starting to output an operation message corresponding to the requested operation.

13. The method according to claim 11, wherein the operation message includes at least one of an image processing message and an error message.

14. An image processing apparatus comprising:
storage means for storing a standby message, an operation message, and an additional message, the standby message indicating a standby condition of the image processing apparatus, and the operation message indicating an operation condition of the image processing apparatus; and
notification means for selectively outputting the messages obtainable from the storage means and for switching from an output of the standby message to an output of the additional message when a time period elapsing from a start of displaying the standby message exceeds a reference value.

15. The image processing apparatus according to claim 1, wherein the notification unit includes a display unit to produce a visual output.

16. The method according to claim 11, further comprising:
receiving an indication, regarding the additional message, to operate according to one of an output-mode and a non-output mode.

17. The method according to claim 11, wherein the notification unit includes a display unit to produce a visual output.

18. The method according to claim 11, wherein:
there is a plurality of additional messages including at least a first additional message and a second additional message, and
the method further comprises at least the following,
switching a message being output on the notification unit from the first additional message to the second additional message when a request for the second additional message is received during output of the first additional message.

19. The method according to claim 11, wherein the reference value is a variable.

20. The method according to claim 11, further comprising:
receiving user-information via an interface to the image processing apparatus; and
generating the additional message according to the user-information.
